(19) United States
(12) Patent Application Publication
(10) Pub. No.: US 2025/0316870 A1
(43) Pub. Date: Oct. 9, 2025

(54) SECONDARY BATTERY

(71) Applicant: SAMSUNG SDI CO., LTD., Yongin-si (KR)

(72) Inventor: Byung Huy CHO, Yongin-si (KR)

(21) Appl. No.: 18/907,550

(22) Filed: Oct. 6, 2024

(30) Foreign Application Priority Data
Apr. 3, 2024 (KR) 10-2024-0045196

(51) Int. Cl. H01M 50/655; H01M 50/103; H01M 50/186; H01M 50/193; H01M 50/342

(52) U.S. Cl. CPC H01M 50/655; H01M 50/103; H01M 50/186; H01M 50/193; H01M 50/3425; H01M 2200/20; H01M 2220/20

(57) ABSTRACT

A secondary battery is configured such that a vent recess is provided in a rivet configured to seal an electrolyte injection port of a case and the vent recess is fractured if the internal pressure of the case increases, whereby internal gas is discharged, and therefore the secondary battery is made safer. The secondary battery includes an electrode assembly having a first electrode plate and a second electrode plate, a case in which the electrode assembly is received, and a rivet extending through a side of the case. The rivet includes vent recess, and a region of the rivet having the vent recess is thinner than other regions of the rivet.

### CROSS-REFERENCE TO THE RELATED APPLICATION

The present application claims priority to and the benefit of Korean Patent Application No. 10-2024-0045196, filed on Apr. 3, 2024, in the Korean Intellectual Property Office, the entire disclosure of which is incorporated herein by reference.

### BACKGROUND

### 1. Field

Embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

Embodiments of the present disclosure provide a secondary battery configured such that an electrolyte injection port of a case is pressed and sealed by a rivet and sealing force is increased by a sealing member that is interposed between the rivet and the case.

Embodiments of the present disclosure provide a secondary battery configured such that a vent recess provided in a rivet is fractured if the internal pressure of a case increases, whereby internal gas is discharged, and the secondary battery is thereby made safer.

These and other aspects and features of the present disclosure will be described in or will be apparent from the following description of embodiments of the present disclosure.

A secondary battery according to an embodiment of the present disclosure includes an electrode assembly having a first electrode plate and a second electrode plate, a case in which the electrode assembly is received, and a rivet extending through one surface of the case, the rivet including a vent recess, and a region of the rivet that includes vent recess is thinner than other regions of the rivet.

The rivet may include a rivet body inserted into an electrolyte injection port formed in the case and a rivet mandrel extending through and coupled to the rivet body, the vent recess being provided at a lower side of the rivet mandrel.

The rivet body may be interposed between the rivet mandrel and the electrolyte injection port.

The rivet body may include a body head portion located outside the case, a body extension portion extending from the body head portion towards an inside of the case, the body extension portion being located in the electrolyte injection port, and a body flange portion extending from the body extension portion in the inward direction towards an inside of the case, the body flange portion being located in the case.

The body extension portion may be formed in a hollow cylindrical shape, the body head portion may be connected to an upper end of the body extension portion, and the body flange portion may be connected to a lower end of the body extension portion.

The outer diameter of each of the body head portion and the body flange portion may be greater than the outer diameter of the body extension portion.

The inner diameter of the body flange portion may be greater than the inner diameter of each of the body head portion and the body extension portion.

The secondary battery may further include a sealing member interposed between the body head portion and the case.

The sealing member may be made of rubber or silicone.

The rivet mandrel may include a mandrel head portion located in the case and a mandrel extension portion extending upward from the center of an upper end of the mandrel head portion.

The mandrel extension portion may have a cylindrical shape and may include a fracture portion that is thinner than other regions such that the fracture portion is configured to be fractured after riveting.

The vent recess may be a notch formed upward from the center of a lower end of the mandrel head portion.

The mandrel head portion may have a diameter greater than the diameter of the mandrel extension portion.

An outer region of the upper end of the mandrel head portion may be inclined relative to an adjacent part of the case.

The mandrel head portion may be located in the inner diameter of the body flange portion, and the body flange portion may have a shape corresponding to the shape of an outer surface of the mandrel head portion.

A region of the rivet mandrel that includes the vent recess is thinner than other regions of the rivet mandrel, and the thickness of the region of the rivet mandrel that includes the vent recess may be 0.1 to 0.2 mm.

The rivet may be a closed rivet.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is a perspective view showing a secondary battery according to an embodiment of the present disclosure;

FIG. 2 is a sectional view of the secondary battery taken along line 2-2 of FIG. 1;

FIG. 3 is a sectional view of an electrode assembly in the secondary battery shown in FIGS. 1 and 2;

FIG. 4 is an enlarged view showing a rivet in the secondary battery of FIG. 2;

FIG. 5 is an enlarged view showing the rivet of FIG. 4 before riveting;

FIG. 6 is a perspective view showing a secondary battery according to another embodiment the present disclosure;

FIG. 7 is a sectional view of the secondary battery taken along line 7-7′ of FIG. 6;

FIGS. 8A and 8B are perspective views showing a battery pack including an exemplary secondary battery according to an embodiment of the present disclosure; and

FIGS. 9A and 9B are perspective and side views showing a vehicle including an exemplary battery pack according to an embodiment of the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

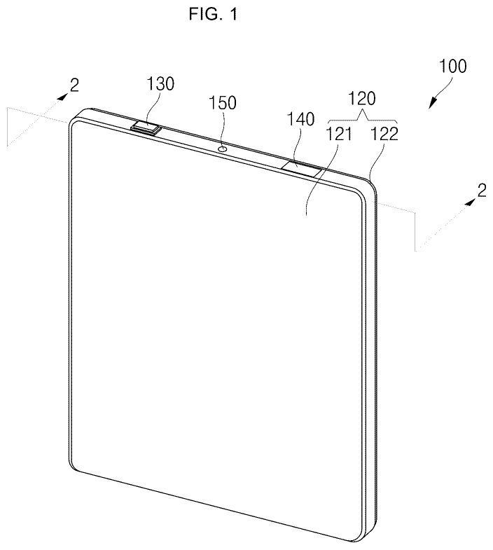

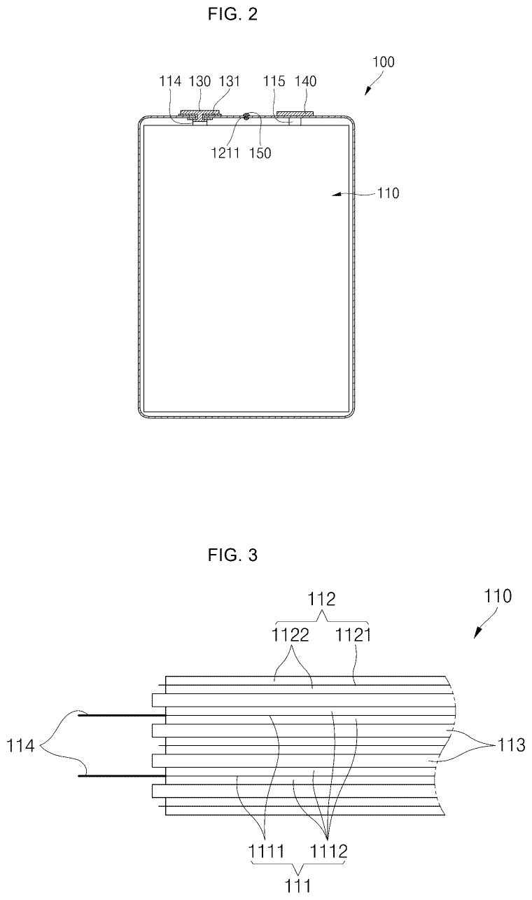

FIGS. 1 and 2 are perspective and sectional views showing an exemplary secondary battery 100 according to an embodiment of the present disclosure. FIG. 2 is a sectional view taken along line 2-2′ of FIG. 1. As shown in FIGS. 1 to 3, the secondary battery 100 according to the embodiment of the present disclosure may include an electrode assembly 100 and a case 120 configured to receive the electrode assembly 100. FIG. 3 is an enlarged sectional view showing a part of the electrode assembly 120 for the secondary battery 100 shown in FIGS. 1 and 2.

The case 120 may include a first case 121 formed in a cuboidal shape and having one open surface and a second case 122 coupled to the one open surface of the first case 121. The case 120 may provide the outer appearance of the secondary battery 100. The case 120 may include or be referred to as a can, a housing, or a cladding. Each of the first case 121 and the second case 122 may include steel, nickel-plated steel, or a steel alloy. The first case 121 may include a rectangular front surface and an upper surface, a lower surface, and two side surfaces extending from four sides of the front surface in a direction toward a rear surface thereof. The upper surface, the lower surface, and the two side surfaces of the first case 121 may have the same width. The second case 122 may be coupled to the open rear surface of the first case 121 to form the hexahedral case 120. A space may be provided in the first case 121. The second case 122 may have an approximately flat shape or a cuboidal shape having a space defined therein and an open front surface. The first case 121 and the second case 122 may be coupled to each other in a sealed state by welding. The case 120 may have a shape enclosing the electrode assembly 110, and the shape of the case may be made to correspond to the shape of the electrode assembly 110.

The electrode assembly 110 may be received in the case 120 together with an electrolytic solution. The electrode assembly 110 may include or be referred to as an electrode group, an electrode body, or a jellyroll. The electrode assembly 110 may include a first electrode plate 111, a second electrode plate 112, and a separator 113 disposed between the first electrode plate 111 and the second electrode plate 112. The electrode assembly 110 may be made in various configurations. For example, the electrode assembly 110 may be stacked into a sheet shape or may be wound into a jelly roll shape. In the electrode assembly 110, the first electrode plate 111, the separator 113, the second electrode plate 112, and the separator 113 may be alternately stacked in that order. The separator 113 or the second electrode plate 112 may be located on the outermost side of the electrode assembly 110, and the case 120 and the first electrode plate 111 may be electrically separated from each other.

The first electrode plate 111 may include a first substrate 1111 and a first active material layer 1112 located on the first substrate 1111. A first non-coated portion of the first substrate 1111 on which the first active material layer 1112 is not located, i.e., a first electrode tab 114, may extend outward, and the first electrode tab 114 may be electrically connected to a first terminal 130. The second electrode plate 112 may include a second substrate 1121 and a second active material layer 1122 located on the second substrate 1121. A second non-coated portion of the second substrate 1121 on which the second active material layer 1122 is not located, i.e., a second electrode tab 115, may extend outward, and the second electrode tab 115 may be electrically connected to a second terminal 140. The first electrode tab 114 and the second electrode tab 115 may protrude and extend outward from one side of the electrode assembly 110. The first electrode tab 114 and the second electrode tab 115 may be spaced apart from each other at one side of the electrode assembly 110. One side of the electrode assembly 110 may be an upper side. The first electrode tab 114 and the second electrode tab 115 may be spaced apart from each other at the upper side of the electrode assembly 110 in a first direction, which is a longitudinal direction. In another example, the first electrode tab 114 and the second electrode tab 115 may be separate lead tabs in contact with and coupled to the first non-coated portion and the second non-coated portion of the electrode assembly 110, respectively.

The first electrode plate 111 may function as a positive electrode. In such a case, the first substrate may be made of, for example, aluminum foil, and the first active material layer may include, for example, a transition metal oxide. The second electrode plate 112 may function as a negative electrode. In such a case, the second substrate may be made of, for example, copper foil or nickel foil, and the second active material layer may include, for example, graphite. The separator 113 may prevent short circuit between the first electrode plate 111 and the second electrode plate 112 while allowing migration of the lithium ions between the plates 111 and 112. The separator 113 may be made of, for example, a polyethylene film, a polypropylene film, or a polyethylene-polypropylene film.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D₆₀ (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The secondary battery 100 may further include a first terminal 130 and a second terminal 140 provided at an upper surface of the case 120. The first terminal 130 may be electrically isolated from the case 120 and may be in contact with and electrically connected to the first electrode tab 114 of the electrode assembly 110. The first electrode tab 114 of the electrode assembly 110 may be located between the first terminal 130 and the upper side of the electrode assembly 110.

An insulating member 131 may be interposed between the first terminal 130 and the case 120. The first terminal 130 may extend through the case 120 such that an upper part of the first terminal is exposed and protrudes to outside of the case 120. The first terminal 130 may extend through the case 120 such that a lower part of the first terminal is located in the case 120, and the first electrode tab 114 of the electrode assembly 110 may be in contact with and coupled to a lower end of the first terminal 130 by welding. In some examples, the insulating member 131 may include or be referred to as a gasket. Although the insulating member 131 is shown as a single piece, the present disclosure is not limited thereto, and the insulating member may include an insulating member in contact with an outer surface of the case 120, an insulating member in contact with an inner surface of the case 120, and a gasket located in a terminal hole of the case 120.

The second terminal 140 may be in contact with and electrically connected to the case 120. The second terminal 140 may be a part of the case 120. The second terminal 140 may be electrically connected to the second electrode tab 115 of the electrode assembly 110. For example, the second electrode tab 115 may be in contact with and electrically connected to the case 120. The second terminal 140 may be electrically connected to the second electrode tab 115 of the electrode assembly 110 via the case 120. The second electrode tab 115 may be located between the second terminal 140 and the upper side of the electrode assembly 110.

The secondary battery 100 may further include a rivet 150 provided at the upper surface of the case 120. The case 120 may further include an electrolyte injection port 1211 provided in the upper surface between the first terminal 130 and the second terminal 140, and the electrolyte injection port 1211 may be sealed by the rivet 150. The electrolyte injection port 1211 may be located in the middle of the upper surface of the case 120 in the longitudinal direction. The electrolyte injection port 1211 may be located in the middle of the upper surface of the case 120 because the middle may be most affected by internal pressure.

The present disclosure is not limited to the configuration shown in FIGS. 1 to 3. For example, the case may have any of various shapes, such as a circular shape or a pouch shape. The case may be made of metal, such as aluminum, an aluminum alloy, or nickel-plated steel, or laminated film or plastic constituting a pouch.

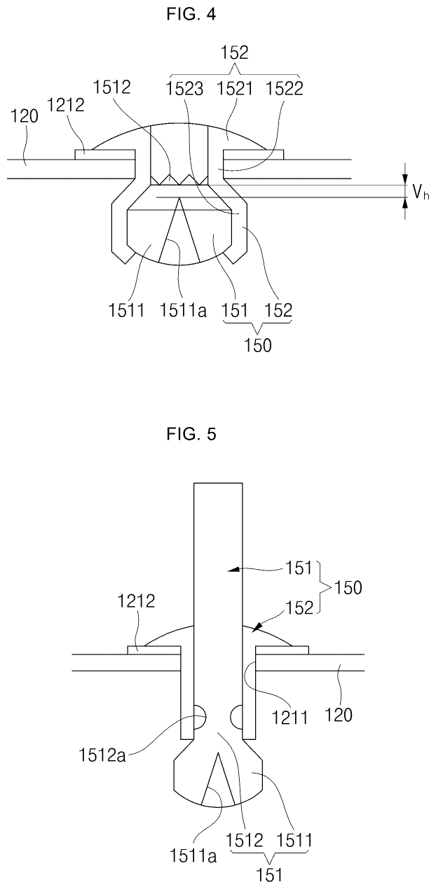

FIG. 4 is an enlarged view showing the rivet 150 in the secondary battery 100 of FIG. 2, and FIG. 5 is an enlarged view showing the rivet 150 of FIG. 4 before riveting. Hereinafter, the rivet 150 will be described with reference to FIGS. 4 and 5.

The rivet 150 may be coupled to the electrolyte injection port 1211 provided in the upper surface of the case 120 to seal the electrolyte injection port 1211 of the case 120. In forming the secondary battery 100, the first case 121 and the second case 122 may be coupled to each other with the electrode assembly 110 is received within the coupled cases. Subsequently, an electrolyte may be injected into the case 120 through the electrolyte injection port 1211. After injection of the electrolyte, the electrolyte injection port 1211 may be sealed by the rivet 150. The rivet 150 may penetrate the upper surface of the case 120 through the electrolyte injection port 1211. The rivet 150 may be fitted into the electrolyte injection port 1211 and then riveted to seal the electrolyte injection port 1211. The rivet 150 may be a blind rivet and closed. The rivet 150 may be made, for example, of aluminum, an aluminum alloy, stainless steel, steel, or a material equivalent thereto.

The rivet 150 may include a rivet mandrel 151 and a rivet body 152. The rivet body 152 may enclose an outer surface of the rivet mandrel 151. The rivet body 152 may penetrate the case 120 through the electrolyte injection port 1211, and the rivet mandrel 151 may penetrate the rivet body 152. The rivet body 152 may be located between the rivet mandrel 151 and the electrolyte injection port 1211 of the case 120.

The rivet body 152 may include a body head portion 1521 located outside the case 120, a body extension portion 1522 extending from the body head portion 1521 in an inward direction of the case 120. The body extension portion may be located in the electrolyte injection port 1211, and a body flange portion 1523 extending from the body extension portion 1522 in the inward direction of the case 120, with the body flange portion being located in the case 120. The body extension portion 1522 may have a hollow cylindrical shape. The body head portion 1521 may extend from an upper end of the body extension portion 1522 in an outward direction. The outer diameter of the body head portion 1521 may be greater than the outer diameter of the body extension portion 1522. The inner diameter of the body head portion 1521 and the inner diameter of the body extension portion 1522 may be the same. The diameter of the body head portion 1521 may be greater than the diameter of the body extension portion 1522 and may be equal to or less than the width of the upper surface of the case 120. The body head portion 1521 may be approximately circular, but the body head portion 1521 is not limited to such a shape.

The body head portion 1521 may be located above the upper surface of the case 120. The body flange portion 1523 may extend downward from a lower end of the body extension portion 1522 and may be a region that is deformed according to the outer surface shape of the mandrel head portion 1511 of the rivet mandrel 151. The diameter (outer diameter) of the body flange portion 1523 may be greater than the diameter of the body extension portion 1522. The inner diameter of the body flange portion 1523 may be greater than the inner diameter of the body head portion 1521 and the inner diameter of the body extension portion 1522.

A sealing member 1212 may be interposed between the body head portion 1522 and the case 120. The sealing member 1212 may be a gasket made of rubber or silicone, and the sealing member 1212 may be pressed between the rivet 150 and the case 120 so as to be tight contact with the rivet 150 and the case 120 after riveting of the rivet 150. In another example, the sealing member 1212 may be interposed between the inner surface of the case 120 and the body flange portion 1523. As a further example, the sealing member 1212 may be interposed between the electrolyte injection port 1211 of the case 120 and the body extension portion 1522. The sealing member 1212 may be interposed between the case 120 and the rivet body 152, and the sealing member 1212 may be pressed after riveting of the rivet 150 to form a seal between the case 120 and the rivet 150 by being pressed against the case 120 and the rivet 150.

The rivet mandrel 151 may include a mandrel head portion 1511 located in the case 120 and a mandrel extension portion 1512 extending upward from the mandrel head portion 1511. The mandrel extension portion 1512 may be approximately cylindrical. The mandrel extension portion 1512 may include a fracture portion 1512a provided at an outer surface thereof as a groove extending in a direction towards the central axis of the rivet mandrel 151 before riveting, whereby the rivet mandrel as less thickness in the region of the fracture portion than the other regions. The fracture portion 1512a may be a portion that is fractured after the mandrel head portion 1511 is pressed and deforms the body flange portion 1523 of the rivet body 152 upon riveting. Thus, only the region of the rivet mandrel 151 under the fracture portion 1512a may remain after riveting. The body flange portion 1523 may be in tight contact with an outer surface of the mandrel head portion 1511 and may have a shape corresponding to the shape of the outer surface of the mandrel head portion 1511.

The mandrel head portion 1511 may have a larger diameter than the mandrel extension portion 1512. An upper end of the mandrel head portion 1511 may be connected to a lower end of the mandrel extension portion 1512 at an approximate middle of the upper end of the mandrel head portion 1511. An upwardly notched vent recess 1511a may be provided in approximate middle of a lower surface of the mandrel head portion 1511. The vent recess 1511a may be a rectangular or arc-shaped recess forming a notch, and the shape of the vent recess may vary. At least a part of a vent region may have a smaller thickness than the remaining part of the vent region due to the notch formed as the vent recess 1511a.

An upper end of the vent recess 1511a may be located lower than the fracture portion 1512a. If the fracture portion 1512a of the rivet mandrel 151 is fractured by riveting, the vent region, which is at an approximate central region of the head portion 1522, may be thinner than the other regions by the vent recess 1511a. If the internal pressure of the case 120 increases, the notch formed by the vent recess 1511a is fractured, whereby the vent region is opened to allow internal gas to escape to outside of the secondary battery. In some examples, the thickness of the vent region may be 0.1 to 0.2 mm. If the thickness of the vent region is less than 0.1 mm, it may be difficult to maintain rigidity of the rivet mandrel 151 due to the vent recess 1511a. If the thickness of the vent region is greater than 0.2 mm, it may be difficult for the vent recess 1511a to fracture if the internal pressure of the case 120 increases.

An outer region of an upper end of the mandrel head portion 1511 connected to the mandrel extension portion 1512 may be inclined downward. Such a configuration may facilitate insertion of the mandrel head portion 1511 into the body flange portion 1523 to thereby facilitate deformation of the body flange portion 1523 upon riveting through the rivet mandrel 151. The body flange portion 1523 may be deformed so as to correspond to the external shape of the mandrel head portion 1511, and, thus, the body flange portion may have a larger diameter than the mandrel extension portion 1512. The mandrel head portion 1511 may press the body flange portion 1523 and may seal a hole formed through the center of the rivet body 152.

In the secondary battery 100, the electrolyte injection port 1211 of the case 120 may be pressed and sealed through the rivet 150, and sealing force may be increased by the sealing member 1212 interposed between the rivet 150 and the case 120. If the internal pressure of the case 120 increases, the vent recess 1511a provided in the rivet 150 may be fractured to vent internal gas, thereby making the secondary battery 100 more safe.

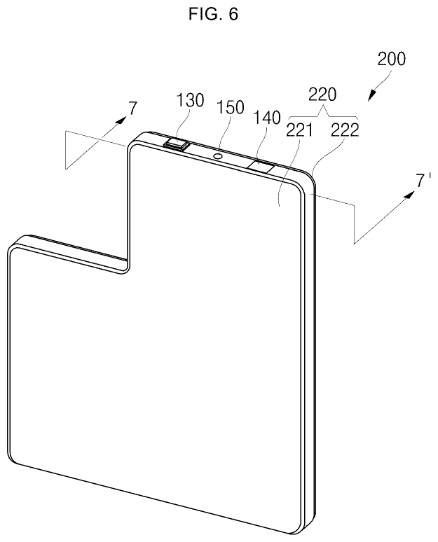

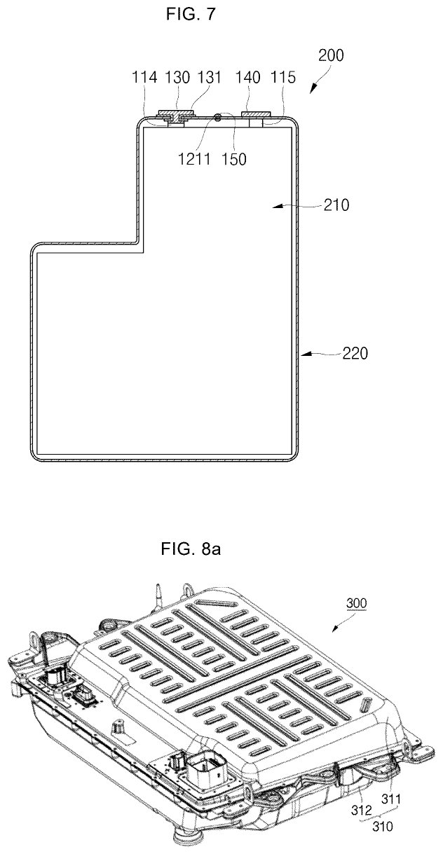

FIGS. 6 and 7 are perspective and sectional views showing an exemplary secondary battery 200 according to another embodiment of the present disclosure. FIG. 7 is a sectional view taken along line 7-7′ of FIG. 6. As shown in FIGS. 6 and 7, the secondary battery 200 according to the other embodiment of the present disclosure may include an electrode assembly 210 and a case 220 configured to receive the electrode assembly 210. The secondary battery 200 may further include a first terminal 130 and a second terminal 140 provided at an upper surface of the case 220. The first terminal and the second terminal may be electrically connected to the electrode assembly 210, and a rivet 150 may be provided at the upper surface of the case 220.

The first terminal 130, the second terminal 140, and the rivet 150 of the secondary battery 200 may be similar to the first terminal 130, the second terminal 140, and the rivet 150 of the secondary battery 100 shown in FIGS. 1 to 3. Hereinafter, aspects of the electrode assembly 210 and the case 220 of the secondary battery 200 that are different from the above-described electrode assembly 110 and the case 120 of the secondary battery 100 will be described.

The case 220 may include a first case 221 having one open surface and a second case 222 coupled to the one open surface of the first case 221. The case 220 may include or be referred to as a can, a housing, or a cladding. Each of the first case 221 and the second case 222 may include steel, nickel-plated steel, or a steel alloy. The case 220 may provide the outer appearance of the secondary battery 200.

The width of an upper surface of the first case 221 at a lower region in a first direction, which is a longitudinal direction, may be greater than the width of the upper surface of the first case 221 at an upper region. The width of a front surface of the first case 221 at a lower region may be greater than the width of the front surface of the first case 221 at an upper region. In the front surface of the first case 221, an upper side, a lower side, and one side may be straight, and the other side may be stepped. For example, the front surface of the first case 221 may have an L shape. The first case 221 may also include an upper surface, a lower surface, and two side surfaces extending from respective sides of the front surface in a rearward direction. The upper surface, the lower surface, and the two side surfaces of the first case 121 may have the same width. However, one side surface of the first case 221 may be curved and may extend so as to correspond to the shape of the front surface.

The second case 222 may be coupled to the open rear surface of the first case 221 to form the case 220. A space may be provided in the first case 221. The second case 222 may have an approximately flat shape or a shape having a space defined therein and an open front surface. The shape of the second case 222 may have a shape corresponding to the shape of the front surface of the first case 221. The first case 221 and the second case 222 may be coupled to each other in a sealed state by welding. The case 220 may have a shape enclosing the electrode assembly 210, and the shape of the case may be made to correspond to the shape of the electrode assembly 210.

The electrode assembly 210 may be received in the case 220 together with an electrolytic solution. The electrode assembly 210 may include or be referred to as an electrode group, an electrode body, or a jellyroll. The electrode assembly 210 may include a first electrode plate, a second electrode plate, and a separator disposed between the first electrode plate and the second electrode plate. The electrode assembly 210 may be stacked into a sheet shape. In the electrode assembly 210, the first electrode plate, the separator, the second electrode plate, and the separator may be alternately stacked in that order. The separator or the second electrode plate may be located on the outermost side of the electrode assembly 210, and the case 220 and the first electrode plate may be electrically separated from each other.

The first electrode plate, the second electrode plate, and the separator may be flat, may have a width at a lower region thereof greater than the width at an upper region thereof, and may have a shape corresponding to the shape of the front surface of the case 220. The first electrode plate, the second electrode plate, and the separator, each of which may have an L shape, may be alternately stacked to form the electrode assembly 210. The shape of the electrode assembly 210 may vary. A first electrode tab and a second electrode tab of the electrode assembly 210 may protrude upward and may be in contact with and electrically connected to the first terminal 130 and the second terminal 140, respectively.

The section of the electrode assembly 210 may be similar to the section of the electrode assembly 110 shown in FIG. 3, and the connection of the electrode assembly to the first terminal 130 and the second terminal 140 may be similar to the connection of the electrode assembly to the first terminal and the second terminal in the secondary battery 100.

The secondary battery according to the above-described embodiment can be used to manufacture a battery pack.

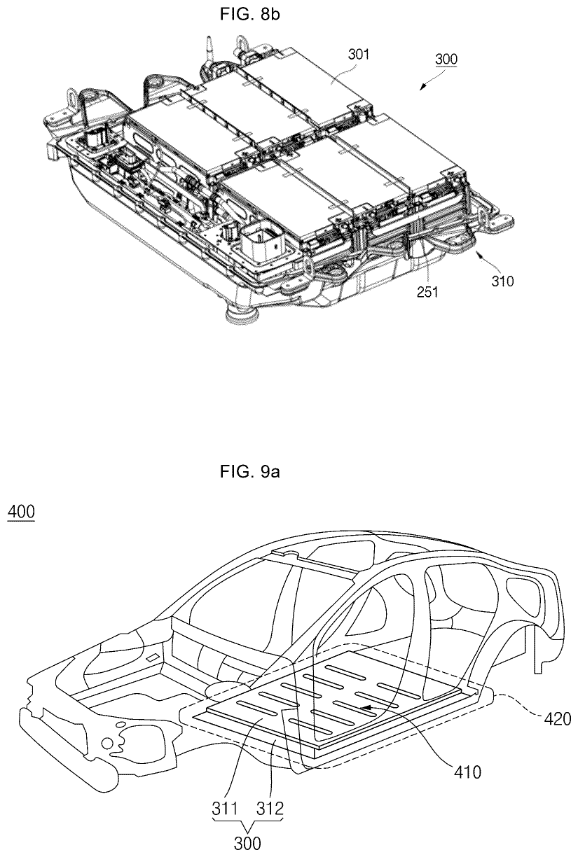

FIGS. 8A and 8B are perspective views showing an exemplary battery pack 300. The battery pack 300 may include a plurality of battery modules 301 and a housing 310 configured to accommodate the plurality of battery modules 301. For example, the housing 310 may include a first housing 311 and a second housing 312, which are coupled to each other in directions facing each other with the plurality of battery modules 200 interposed therebetween. The plurality of battery modules 301 may be electrically connected to each other using bus bars 251. The plurality of battery modules 301 may be electrically connected to each other in series, in parallel, or in a combination thereof, so that desired electrical output may be obtained.

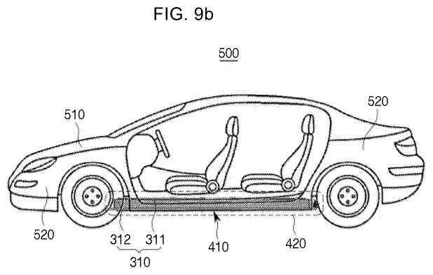

FIGS. 9A and 9B are, respectively, a perspective view showing an exemplary vehicle body 400 and a side view showing an exemplary vehicle 500. As shown in FIG. 9A, the battery pack 300 may include a battery pack cover 311 (which may correspond to the first housing), which is a portion of a vehicle underbody 410, and a pack frame 312 (which may correspond to the second housing), which is disposed beneath the vehicle underbody 410. The battery pack cover 311 and the pack frame 312 may be integrally formed with a vehicle bottom portion 420. The vehicle underbody 410 may separate the interior and the exterior of the vehicle from each other, and the pack frame 312 may be disposed outside the vehicle.

As shown in FIG. 9B, the vehicle 500 may include a vehicle body 400 and various parts coupled to the vehicle body 400, such as a hood 510 located at the front portion of the vehicle and fenders 520 located at the front and rear portions of the vehicle. The vehicle 500 may include the battery pack 300 including the battery pack cover 311 and the pack frame 312, and the battery pack 300 may be coupled to the vehicle body 400.

As is apparent from the above description, embodiments of the present disclosure provide a secondary battery configured such that an electrolyte injection port of a case is pressed and sealed by a rivet, sealing force is increased by a sealing member interposed between the rivet and the case. Further, a vent recess provided in the rivet is fractured if the internal pressure of the case increases, whereby internal gas is discharged, and therefore the secondary battery is made safer.

According to another aspect of the present disclosure, a battery pack manufactured using a battery with an improved structure and a vehicle including the same can be provided.

However, the aspects and features of the present disclosure are not limited to those described above, and other aspects and features not expressly described herein will be clearly understood by a person skilled in the art from the description of example embodiments of the present disclosure.

Although the present disclosure has been described above with reference to limited embodiments and drawings, the present disclosure is not limited thereby and various modifications and variations may be made by a person having ordinary skill in the art to which the present disclosure pertains within the technical ideas of the present disclosure and the equivalent scope of the appended claims.

What is claimed is:

1. A secondary battery comprising:
an electrode assembly including a first electrode plate and a second electrode plate;
a case in which the electrode assembly is received; and
a rivet extending through a side of the case, the rivet including a vent recess, and
wherein a region of the rivet that includes the vent recess is thinner than other regions of the rivet.

2. The secondary battery as claimed in claim 1, wherein the rivet comprises:
a rivet body inserted into an electrolyte injection port formed in the case; and
a rivet mandrel extending through and coupled to the rivet body, with the vent recess being provided at a lower side of the rivet mandrel.

3. The secondary battery as claimed in claim 2, wherein the rivet body is interposed between the rivet mandrel and the electrolyte injection port.

4. The secondary battery as claimed in claim 2, wherein the rivet body comprises:
a body head portion located outside the case;
a body extension portion extending from the body head portion towards an inside of the case, the body extension portion being located in the electrolyte injection port; and
a body flange portion extending from the body extension portion towards the inside of the case, the body flange portion being located in the case.

5. The secondary battery as claimed in claim 4, wherein the body extension portion is formed in a hollow cylindrical shape, the body head portion is connected to an upper end of the body extension portion, and the body flange portion is connected to a lower end of the body extension portion.

6. The secondary battery as claimed in claim 4, wherein an outer diameter of each of the body head portion and the body flange portion is greater than an outer diameter of the body extension portion.

7. The secondary battery as claimed in claim 4, wherein an inner diameter of the body flange portion is greater than an inner diameter of each of the body head portion and the body extension portion.

8. The secondary battery as claimed in claim 4, further comprising a sealing member interposed between the body head portion and the case.

9. The secondary battery as claimed in claim 8, wherein the sealing member is made of rubber or silicone.

10. The secondary battery as claimed in claim 2, wherein the rivet mandrel comprises:
a mandrel head portion located in the case; and
a mandrel extension portion extending upward from a center of an upper end of the mandrel head portion.

11. The secondary battery as claimed in claim 10, wherein the mandrel extension portion has a cylindrical shape and comprises a fracture portion that is thinner than other regions such that the fracture portion is configured to be fractured after riveting.

12. The secondary battery as claimed in claim 10, wherein the vent recess is a notch formed upward from a center of a lower end of the mandrel head portion.

13. The secondary battery as claimed in claim 10, wherein the mandrel head portion has a diameter greater than a diameter of the mandrel extension portion.

14. The secondary battery as claimed in claim 13, wherein an outer region of an upper end of the mandrel head portion is inclined relative to an adjacent part of the case.

15. The secondary battery as claimed in claim 13, wherein the mandrel head portion is located in an inner diameter of the body flange portion, and
wherein the body flange portion has a shape corresponding to a shape of an outer surface of the mandrel head portion.

16. The secondary battery as claimed in claim 13, wherein a region of the rivet mandrel that includes the vent recess is thinner than other regions of the rivet mandrel, and
wherein the thickness of the region of the rivet mandrel that includes the vent recess is 0.1 to 0.2 mm.

17. The secondary battery as claimed in claim 1, wherein the rivet is a closed rivet.
